(19) United States
(12) Patent Application Publication
(10) Pub. No.: US 2023/0325705 A1
(43) Pub. Date: Oct. 12, 2023

(54) METHOD AND SYSTEM FOR ASSOCIATING DIAGNOSTIC CODES WITH PROBLEM-SOLUTION DESCRIPTIONS

(71) Applicant: Robert Bosch GmbH, Stuttgart (DE)

(72) Inventor: HyeongSik Kim, San Jose, CA (US)

(21) Appl. No.: 17/658,759

(22) Filed: Apr. 11, 2022

(51) Int. Cl. G06N 20/00; G06Q 10/00

(52) U.S. Cl. CPC G06N 20/00; G06Q 10/20

(57) ABSTRACT

A method for associating diagnostic codes with problem-solution descriptions is disclosed. The method comprises receiving a first subset of a plurality of training data pairs. Each training data pair in the first plurality of training data pairs includes (i) a respective diagnostic code and (ii) a respective problem-solution description associated with the respective diagnostic code. The method further comprises receiving a plurality of problem-solution descriptions that are not yet associated with any diagnostic codes. The method further comprises generating a second subset of the plurality of training data pairs by associating the plurality of problem-solution descriptions with respective diagnostic codes, using the first subset of the plurality of training data pairs. The method further comprises training a model using on the plurality of training data pairs. The at least one model is configured to associate diagnostic codes with problem-solution descriptions.

### FIELD

The device and method disclosed in this document relates to machine diagnostics and, more particularly, to associating diagnostic codes with problem-solution descriptions.

### BACKGROUND

Unless otherwise indicated herein, the materials described in this section are not admitted to be the prior art by inclusion in this section.

Many modern devices such as automotive engines and welding stations in manufacturing factories are often equipped with self-diagnostic mechanisms. When run-time errors or malfunctions occur on these devices, self-diagnostic mechanisms in these devices return diagnostic codes. Once such codes are identified, the common next step is to check the tables or the websites that summarize all the diagnosis codes and their descriptions. In some cases, such tables or websites provide additional descriptions of the diagnostic codes such as their problems, and solutions, i.e., problem-solution description. However, in many cases, such additional descriptions are not available; many existing problem-solution descriptions are not associated with the diagnostic codes. Instead, the descriptions are often organized by other criteria such as the symptoms from devices, component names, or just randomly listed in manuals or the Internet communities. Generally, the users or the operators of the devices are responsible for associating between diagnostic codes and their problem-solution descriptions using their expertise. They need to manually review all descriptions one by one and determine the relevance with the diagnostic codes, which requires a significant amount of effort and resources.

Many modern devices such as automotive engines and welding stations in manufacturing factories are often equipped with self-diagnostic mechanisms; these devices are supposed to return diagnostic codes, error codes, or parameters when such devices are about to experience any run-time errors or malfunctions, assisting users to easily diagnose core causes of the errors. As a common practice, once users identify such codes, the next steps are about finding potential diagnostic processes and solutions; many documents such as the manuals from manufacturers and discussion threads from various web forums already provide solutions to the problems from the target devices. In some cases, some problem-solution descriptions are already well associated with relevant error codes; thus, users easily understand the problems and try their solutions, quickly resolving the errors. However, many existing problem-solution descriptions are not yet associated with the codes. Instead, such descriptions are often not organized by codes but the symptoms from the devices, the component names, or simply randomly listed, etc. In such cases, the main challenge is that users have to manually review such solutions one by one and determine the relevance of the diagnostic codes, which requires a significant amount of effort and resources.

### SUMMARY

A method for associating diagnostic codes with problem-solution descriptions is disclosed. The method comprises receiving, with a processor, a first subset of a plurality of training data pairs. Each training data pair in the first plurality of training data pairs includes (i) a respective diagnostic code and (ii) a respective problem-solution description associated with the respective diagnostic code. The method further comprises receiving, with the processor, a plurality of problem-solution descriptions that are not yet associated with any diagnostic codes. The method further comprises generating, with the processor, a second subset of the plurality of training data pairs by associating the plurality of problem-solution descriptions with respective diagnostic codes, using the first subset of the plurality of training data pairs. The method further comprises training, with the processor, a model using on the plurality of training data pairs. The at least one model is configured to associate diagnostic codes with problem-solution descriptions.

### BRIEF DESCRIPTION OF THE DRAWINGS

The foregoing aspects and other features of the method are explained in the following description, taken in connection with the accompanying drawings.

FIG. 1 shows an exemplary embodiment of a problem assistance system.

FIG. 2 shows an exemplary problem-solution document for an OBD II diagnostic code called “P0171.”

FIG. 3 shows an exemplary graphical user interface for problem assistance.

FIG. 4 shows an exemplary embodiment of the server or other computing device.

FIG. 5 shows a flow diagram for a method for a developing a model for associating problem-solution descriptions with diagnostic codes.

FIG. 6 shows a flow diagram for a method for a generating additional training data for associating problem-solution descriptions with diagnostic codes.

FIG. 7 shows an exemplary search framework for generating a search index based on the gold-standard training data.

FIG. 8 shows the search framework of FIG. 7 further includes a results generator that determines preliminary associations between an input and one or more diagnostic codes.

FIG. 9 shows an exemplary rule-based filter for filtering and verifying preliminarily associations.

FIG. 10 illustrates an exemplary human-in-the-loop approach for filtering and verifying preliminarily associations.

FIG. 11 shows an exemplary unsupervised learning approach for filtering and verifying preliminarily associations.

FIG. 12 shows an exemplary supervised learning approach for filtering and verifying preliminarily associations.

FIG. 13 shows an exemplary process of constructing knowledge bases from the refined associations.

FIG. 14 shows an example input and output for a summarization of the descriptions of the problems for the diagnostic code “P0171.”

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### System Overview

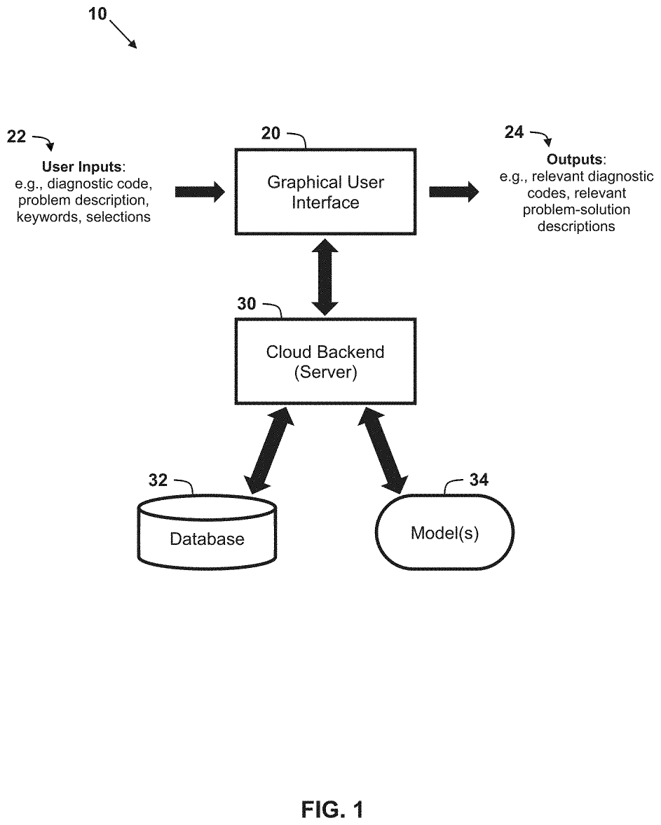

FIG. 1 shows an exemplary embodiment of a problem assistance system 10. The problem assistance system 10 advantageously enables a user to find relevant problem-solution descriptions and relevant diagnostic codes to assist the user in diagnosing and solving problems with a machine or device. In particular, the problem assistance system 10 is useful for assisting the user in diagnosing and solving problems for a machine or device having self-diagnostic mechanisms that return diagnostic codes.

It should be appreciated that many modern devices are often equipped with self-diagnostic mechanisms. For example, engines in most automotive vehicles are now equipped with onboard diagnostic systems, which is a part of the vehicle's electronic system that performs self-diagnosis and reports the error codes. The error codes here are often called On-Board Diagnostics (OBD), a Diagnostic Trouble Codes (DTC), Error Codes, Trouble Codes, or Return Parameters. Whenever any problem is detected, the system in the engine records and reports the problem as a unique code. A vehicle owner or mechanic can then pull that code and interpret it to understand the nature of the problem.

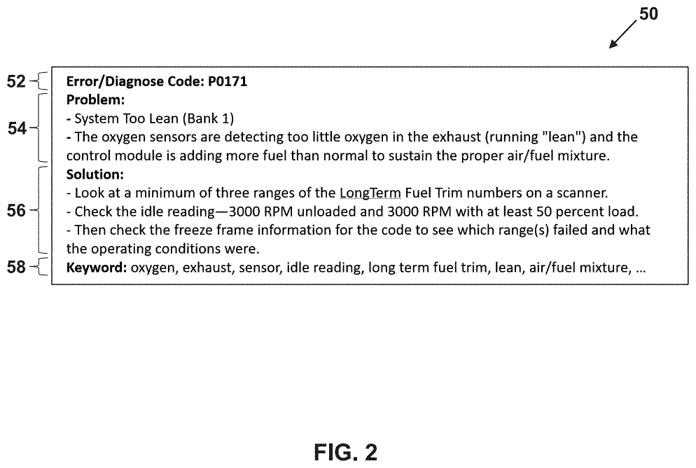

Often, each diagnostic code is associated with at least one problem-solution description that may, for example, be provided by a manufacturer of the machine or device. FIG. 2 shows an exemplary problem-solution document 50 for an OBD II code called “P0171.” As can be seen, the exemplary problem-solution document 50 includes several parts. First, the exemplary problem-solution document 50 includes a diagnostic code 52 identifies the diagnostic code, in this case an OBD II code (e.g., “P0171”), to which the problem-solution document 50 relates. Additionally, the problem-solution document 50 includes a problem description 54 and a solution description 56. The problem description 54 describes a problem, a dilemma, or concerning issue relating to the machine or device (e.g., “System Too Lean (Bank 1). The oxygen sensors are detecting too little oxygen in the exhaust (running “lean”) and the control module is adding more fuel than normal to sustain the proper air/fuel mixture.”). Likewise, the solution description describes something that can or should be done to remedy the problem (e.g., “Look at a minimum of three ranges of the LongTerm Fuel Trim numbers on a scanner. Check the idle reading-3000 RPM with at least 50 percent load. Then check the freeze frame information for the code to see which range(s) failed and what the operating conditions were.”). In the illustrated example, the problem-solution document 50 further includes keywords 58 that list common words or phrases that relate to the problem (e.g., “oxygen, exhaust, sensor, idle reading, long term fuel trim, lean, air/fuel mixture, . . . ”).

Thus, by receiving the diagnostic code “P0171” from a vehicle and retrieving the associated problem-solution document 50, owners or mechanics can avoid checking whole systems in vehicles and instead directly begin checking the issue from the oxygen sensors or any other components related to airflow and fuels, etc. Similar styles of the code sets are also often used in any modern machines such as laser welding devices in manufacturing factories and even simple dishwashers so that the operators in the factories or the users at home can self-diagnose the problem and begin solving the root cause of the problems.

However, it should be appreciated that problem-solution documents provided by a manufacturer of the machine or device are often limited in scope and detail, and represent only a tiny portion of the knowledge than might be useful for solving the problem indicated by a respective diagnostic code. Particularly, problem-solution description is a common pattern of organization used in both formal technical documents and informal information resources. Generally, many problem-solution descriptions often include signal words which may indicate that information in a passage is ordered in the problem and solution pattern of the organization such as “propose”, “solution”, “answer”, “issue”, “problem”, “problematic”, “remedy”, “prevention”, and “fix”. The descriptions of the problems and their solution are later refined and collected, producing a collection or a book of the problems and their solutions. Sometimes, problems are described in a way that symptoms/observations and actual problems. These types of descriptions are available and common across all domains that require some diagnostic process such as domains of medical, mechanical, even in computer science and biology.

For example, manufacturers of other similar machines or devices may provide similar problem-solution documents that might be useful but are not readily associated with the diagnostic code received by a user. Additionally, there may exist a large number of technical manuals or books that include relevant knowledge that is not readily associated with the diagnostic code. Finally, informal information resources, such as Internet forums and support blogs, often include substantial amounts of information from other users with similar problems, as well as from experts in the field, which is not readily associated with the diagnostic code.

The problem assistance system 10 advantageously enables a user to find problem-solution descriptions beyond the limited set of problem-solution documents that might be provided by a manufacturer. Returning to FIG. 1, in the illustrated embodiment, the problem assistance system 10 provides a graphical user interface 20 via which the user can provide user inputs 22, such as a diagnostic code, a problem description (text), or keywords, as well as user interface selections or user interface navigation inputs. Based on these user inputs 22, the graphical user interface 20 displays relevant outputs 24, such as diagnostic codes or problem-solution descriptions that are relevant to the user inputs 22.

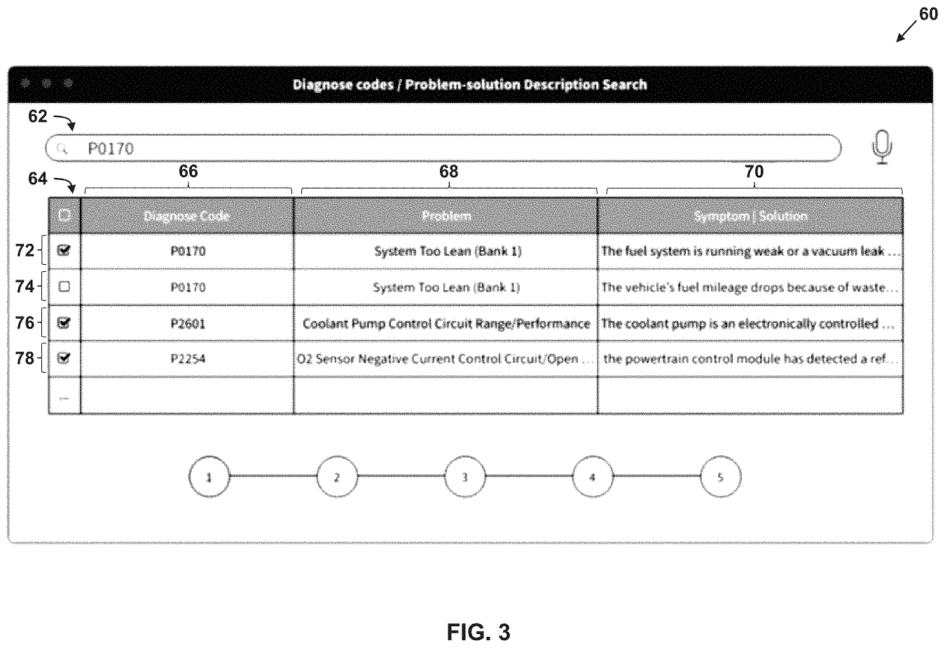

FIG. 3 shows an exemplary graphical user interface 60 for problem assistance. The graphical user interface 60 includes a search box 62 in which the user can type a search query such as a diagnostic code, a problem description, or keywords. In the illustrated example, the user has entered a diagnostic code (e.g., “P0170”) into the search box 62. The graphical user interface 60 additionally includes search results 64. The search result 64 are in the form of a plurality of tuples or database records. As used herein, the terms “tuple” and “database record” should be understood as alternatives. Each tuple comprises a diagnostic code 66, a problem description 68, and a solution description 70. As can be seen, in the illustrated example, the search results 64 include two tuples 72, 74 directly associated with the diagnostic code entered into search box 62 (e.g., “P0170”), which include the same problem description. However, the two tuples 72, 74 include different solutions to the problem. Additionally, the search results 64 include two additional tuples 76, 78 that are associated with different diagnostic codes. These different diagnostic codes might be equivalent diagnostic codes for similar machines or devices, or might simply be different but related diagnostic codes.

Returning to FIG. 1, the graphical user interface 20 may be provided on a display screen of a client device (not shown). The client device may, for example comprise a desktop computer, a laptop, a smart phone, and/or a tablet. The client device, for example, comprises a processor, a memory, transceivers, a user interface, a display screen, and a microphone. The user may operate the client device, in particular a web browser or software application thereon, to display the graphical user interface 20 on the display screen and operate the user interface to provide the user inputs 22.

The search functionality of the graphical user interface 20 may be performed by a cloud backend, referred to hereinafter as the server 30. Particularly, the server 30 is configured to search a database 32 comprising a large number of tuples for tuples that are relevant to the user inputs 22. As in the example of FIG. 2, each tuple at least comprises a diagnostic code, a problem description, and a solution description. In other words, the tuples each establish an association between diagnostic codes and problem-solution descriptions. The database 32 may further comprise a knowledge base have different structure compared to the plurality of tuples. In some embodiments, the database 32 merely stores a large number of problem-solution descriptions, which are unassociated with particular diagnostic codes.

However, the number of known associations between diagnostic codes and problem-solution descriptions may be limited to only the problem-solution documents provided by a manufacturer of the machine or device. Accordingly, one or more models 34 are provided for associating additional problem-solution descriptions with diagnostic codes. The additional problem-solution descriptions may be retrieved from a variety of sources, such as from technical manuals or books retrieved from digital libraries, as well as text information retrieved from Internet forums, blogs, or other websites. The server 30 is configured to use the model(s) 34 to determined additional associations between diagnostic codes and problem-solution descriptions, thereby populating the database 32 with a large number of additional tuples. Additionally, in some embodiments, the server 30 is configured to use the model(s) 34 to perform the aforementioned search of the database. For example, when the user inputs 22 merely include keywords, the server 30 uses use the model(s) 34 to determine diagnostic codes that are associated with the keywords received from the user. As another example, when the user inputs 22 include a diagnostic code, the server 30 uses the model(s) 34 to search a set of problem-solution descriptions that currently unknown associations with the diagnostic codes.

As discussed in greater detail below, techniques and systems that can automatically associate diagnostic codes with the relevant problem-solution descriptions are described, which advantageously enhance the usefulness of the problem assistance system 10. Particularly, the model(s) 34 enable the generation of and continuous maintenance of a large quantity of tuples in the database 32, which thereby enables the problem assistance system 10 to better assist users to quickly find out proper problem-solution descriptions and reduce overall downtime of the devices.

To effectively associate diagnostic codes with relevant problem-solution descriptions, the model(s) 34 utilize a relatively small number of gold-standard problem-solution descriptions with known diagnostic code associations as a basis to determine preliminary associations between diagnostic codes and further unassociated problem-solution descriptions using unsupervised models. The preliminary associations are then cross-checked using heterogeneous stacked models so that high-quality mappings between diagnostic codes and problem-solution descriptions are be produced. The problem assistance system 10 then utilizes such mappings to train supervised models so that the users can easily query over such supervised models or databases populated using those supervised models to find proper problem-solution descriptions quickly.

### Exemplary Hardware Embodiment

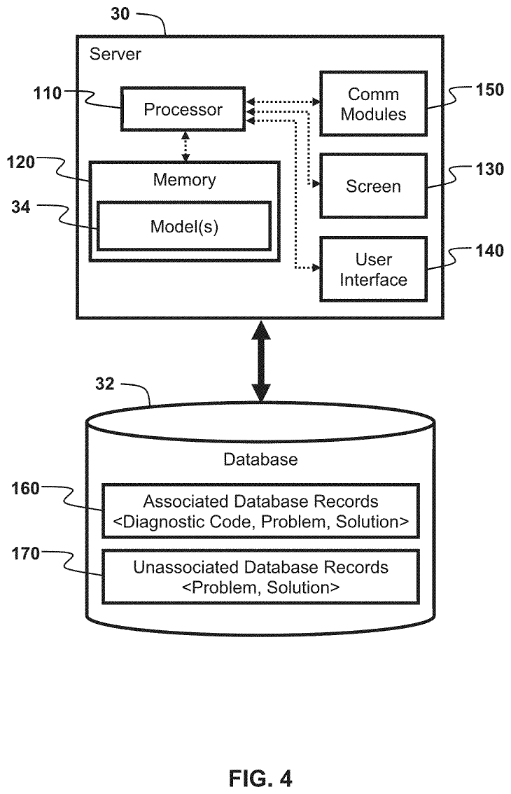

FIG. 4 shows an exemplary embodiment of the server 30 or other computing device that can be used to develop and train the model(s) 34 for associating additional problem-solution descriptions with diagnostic codes, as well as for performing the search functionality of the graphical user interface 20. The server 30 comprises a processor 110, a memory 120, a display screen 130, a user interface 140, and at least one network communications module 150. It will be appreciated that the illustrated embodiment of the server 30 is only one exemplary embodiment is merely representative of any of various manners or configurations of a server, a desktop computer, a laptop computer, or any other computing devices that are operative in the manner set forth herein. The server 30 is in communication with the database 32, which is hosted by another device or which is stored in the memory 120 of the server 30 itself.

The processor 110 is configured to execute instructions to operate the server 30 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the server 30 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 (optional) may comprise any of various known types of displays, such as LCD or OLED screens. The user interface 140 may include a variety of interfaces for operating the server 30, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes a Wi-Fi module configured to enable communication with a Wi-Fi network and/or Wi-Fi router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of the model(s) 34, which are configured to associate additional problem-solution descriptions with diagnostic codes. In at least some embodiments, the database 32 stores a plurality of associated tuples 160, which include problem-solution descriptions associated with respective diagnostic codes. The plurality of associated tuples 160 may include problem-solution documents provided by a manufacturer of the machine or device, as well as problem-solution descriptions that have been previously associated with diagnostic codes by the server 30 using the model(s) 34. Additionally, in at least some embodiments, the database 32 further stores a plurality of unassociated tuples 170, which include problem-solution descriptions that are not yet associated with diagnostic codes. The plurality of unassociated tuples 170 may be retrieved from a variety of sources, such as from technical manuals or books retrieved from digital libraries, as well as text information retrieved from Internet forums, blogs, or other websites.

Methods for Associating Diagnostic Codes with Problem-Solution Descriptions

A variety of methods and processes are described below for operating the server 30 or other computing device to develop and train the model(s) 34 for associating problem-solution descriptions with diagnostic codes. In these descriptions, statements that a method, processor, and/or system is performing some task or function refers to a controller or processor (e.g., the processor 110 of the server 30) executing programmed instructions stored in non-transitory computer readable storage media (e.g., the memory 120 of the server 30) operatively connected to the controller or processor to manipulate data or to operate one or more components in the server 30 or of the database 32 to perform the task or function. Additionally, the steps of the methods may be performed in any feasible chronological order, regardless of the order shown in the figures or the order in which the steps are described.

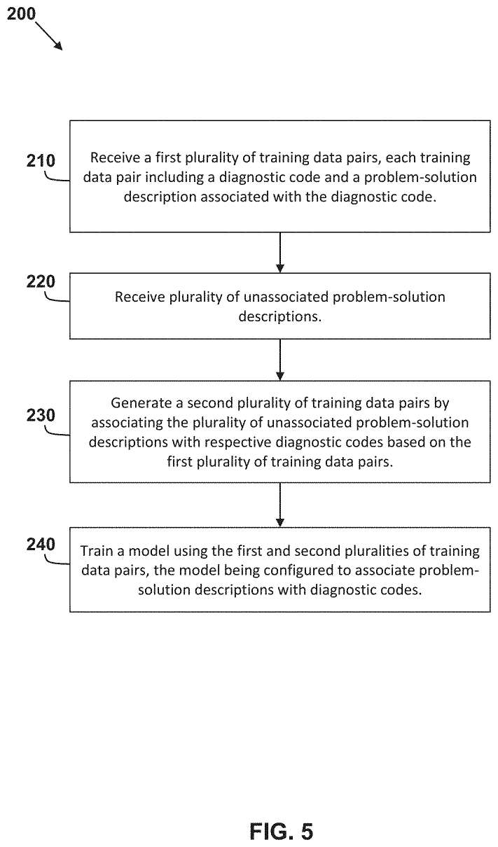

FIG. 5 shows a flow diagram for a method 200 for a developing a model for associating problem-solution descriptions with diagnostic codes. The method 200 advantageously enables the training of model(s) for associating problem-solution descriptions with diagnostic codes. Such model(s) can be utilized for populating a large database of tuples (or database records) or for generating a knowledge base, which can be searched or navigated by users to assist the users in diagnosing and solving problems for a machine or device having self-diagnostic mechanisms that return diagnostic codes. Additionally, in some embodiments, the model(s) can be utilized to search such databases based on user-provided search queries.

The method 200 begins with receiving a first plurality of training data pairs, each training data pair including a diagnostic code and a problem-solution description associated with the diagnostic code (block 210). Particularly, the processor 110 receives and/or the database 32 stores a first plurality of training data pairs, referred to herein as the “gold-standard” training data. The gold-standard training data comprises pairwise associations between diagnostic codes and problem-solution descriptions, and generally form at least as subset of the associated tuples 160, discussed above. The gold-standard training data here denotes a set of clean, well-organized data, in which problem-solution descriptions are already associated with respective diagnostic codes by experts in advance and which, therefore, can be used for training and validation purposes.

It should be appreciated that the gold-standard training data generally includes multiple associations for each diagnostic code, that is to say, multiple problem-solution descriptions are associated with each diagnostic code. Particularly, for an identical problem, different types, processes, or even authors for solving problems can exist. For example, solving the diagnostic code “P0171” in OBD II is related to several parts in a single-engine such as control module software in engines, vacuum leaks in intake manifold gaskets, vacuum hoses, and PCV hoses, etc., or even related to fuel pumps, etc. For this reason, a single diagnostic code can often have multiple associations with different problem-solution descriptions.

Additionally, some problem-solution descriptions may, likewise, be associated with multiple diagnostic codes. Particularly, this is often related to the definition/structures of the codes. For example, in OBD II diagnostic codes, both “P0171” and “P0174” are essentially the identical problem “Fuel System Too Lean.” The reason that there are duplicated diagnostic codes is that, sometimes, a single-engine often has several identical types of components in different locations, such as bank 1 and bank 2. In that case, a single problem-solution can be associated with these two codes because, although their locations are different, the general way of diagnosing and solving the problem is essentially similar or even identical.

In this way, the associations in the gold-standard training data, as well as subsequently determined associations of the diagnostic codes with further problem-solution descriptions, are essentially m: n mappings, which is not common in most labeling problems such as image labeling problems.

Depending on the amount of available gold-standard training data, some steps of the method 200 can be omitted. Particularly, if the amount of the gold-standard training data is considered sufficient, blocks 220 and 230 of the method 200 can be omitted and the method 200 can proceed directly to block 240. The amount of gold-standard training data may be considered sufficient, for example, if there are more than millions of clean, well-associated tuples with different problem-solution descriptions available per diagnostic codes.

However, in many cases, the amount of available gold-standard training data is limited and insufficient (e.g., only a few hundred tuples per diagnostic code). It is, in fact, prevalent that the amount of gold-standard training data is often limited because it generally takes an enormous amount of time for experts to manually label datasets with corresponding diagnostic codes. In these cases, the gold-standard training data is often not sufficient for training any machine learning models to achieve high performance. To relieve this issue, the method 200 utilizes a combination of components that support different weakly-supervised approaches where unassociated problem-solution descriptions are used to provide some supervision signals for labeling large amounts of additional training data (i.e., associating diagnostic codes with additional problem-solution descriptions) using a supervised learning approach.

To these ends, the method 200 continues with receiving plurality of unassociated problem-solution descriptions (block 220). Particularly, the processor 110 receives and/or the database 32 stores a plurality of unassociated problem-solution descriptions. The unassociated problem-solution descriptions comprise problem-solution descriptions that are not yet associated with any diagnostic codes, and generally form the unassociated tuples 170. As discussed above, the unassociated problem-solution descriptions may be retrieved from a variety of sources, such as from technical manuals or books retrieved from digital libraries, as well as from Internet forums, blogs, or other websites.

The method 200 continues with generating a second plurality of training data pairs by associating the plurality of unassociated problem-solution descriptions with respective diagnostic codes based on the first plurality of training data pairs (block 230). Particularly, the processor 110 generates a second plurality of training data pairs, referred to herein as the “semi-gold-standard” training data, using the first plurality of training data pairs, i.e., the gold-standard training data. The semi-gold-standard training data comprises pairwise associations between diagnostic codes and problem-solution descriptions, and generally form a remainder of or at least a subset of the associated tuples 160, discussed above. More particularly, the gold-standard training data and the semi-gold-standard training data collectively comprise the associated tuples 160, which will be used to train at least some of the model(s) 34. Unlike, the gold-standard training data, the semi-gold-standard training data is not manually labeled by experts. Instead, the server 30 generates the semi-gold-standard training data using a combination of components that support different weakly-supervised approaches where unassociated problem-solution descriptions are used to provide some supervision signals.

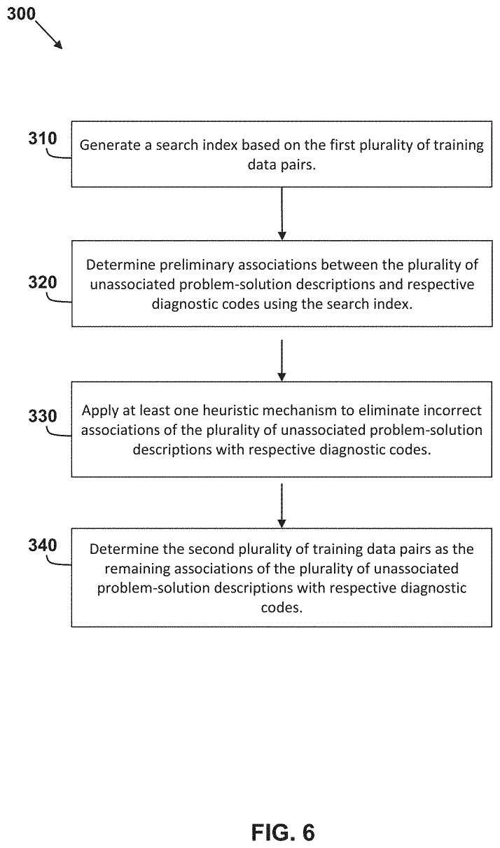

FIG. 6 shows a flow diagram for a method 300 for a generating additional training data for associating problem-solution descriptions with diagnostic codes. The method 300 advantageously leverages the smaller set of gold-standard training data to generate a larger corpus of high-quality semi-gold-standard training data for training the model(s) 34 for associating problem-solution descriptions with diagnostic codes. The method 300 is one exemplary implementation of the block 230 of the method 200.

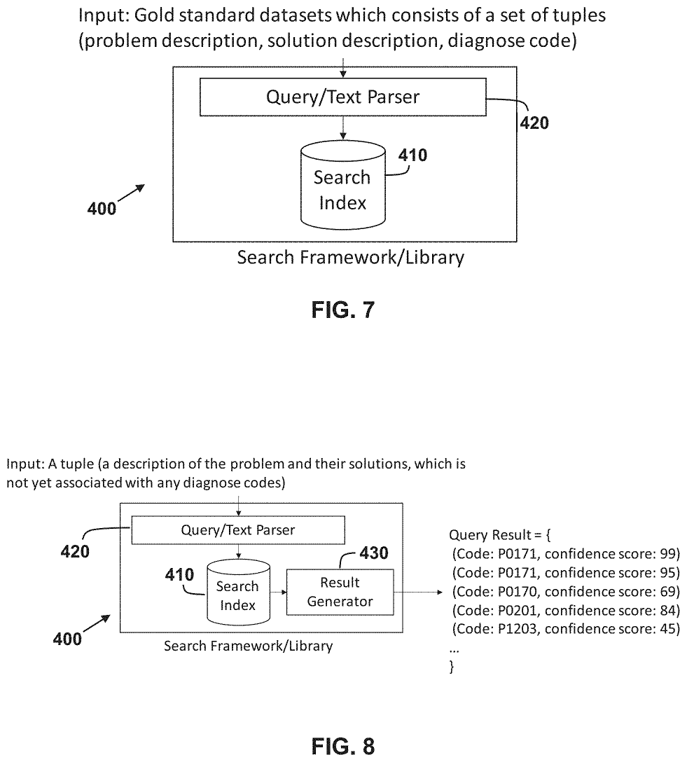

The method 300 begins with generating a search index based on the first plurality of training data pairs (block 310). Particularly, the processor 110 generates a search index based on the gold-standard training data by indexing the text content of the gold-standard training data. FIG. 7 shows an exemplary search framework 400 for generating a search index 410 based on the gold-standard training data. The processor 110 parses the text content of the gold-standard training data using a query/text parser 420. The parsed text content at least includes the problem-solution description of each gold-standard tuple, but the diagnostic code of each gold-standard tuple may also be parsed.

Based on the parsing of the text content of each gold-standard tuple, the processor 110 generates, updates, and/or refines the search index 410. The processor 110 can be configured to generate the search index 410 using a variety of known indexing data structures and techniques implemented in many available public libraries such as suffix tree, inverted index, n-gram index, or document-term matrix. In some embodiments, the search index 410 is implemented using an open-source framework or software library, such as Apache Lucene or Whoosh.

In its simplest form, the search index 410 comprises a table listing every word in the corpus of problem-solution descriptions in the gold-standard training data, and for each word, a list of problem-solution descriptions and/or gold-standard tuples in which the respective word appears. In some embodiments, the search index 410 also identifies additional information, such as how many times the word appears in each problem-solution description or the positions at which the word appears in each problem-solution description.

In any case, since diagnostic codes are already associated with each problem-solution description in the gold-standard training data, each word in the search index 410 is implicitly associated with the diagnostic codes associated with the problem-solution descriptions in which the respective word appears. Thus, as discussed in detail below, the search framework 400 and the search index 410 thereof can be used to match text from unassociated problem-solution descriptions with the gold-standard problem-solution descriptions and their associated diagnostic codes.

Returning to FIG. 6, the method 300 continues with determining preliminary associations between the plurality of unassociated problem-solution descriptions and respective diagnostic codes using the search index (block 320). Particularly, the processor 110 determines preliminary associations between the plurality of unassociated problem-solution descriptions (e.g., the unassociated tuples 170) and respective diagnostic codes (e.g., any diagnostic code for which there was gold-standard training data) using the search index 410. As shown in FIG. 8, the search framework 400 further includes a results generator 430 that utilizes the search index 410 to match an input query (e.g., one of the unassociated problem-solution descriptions) with one or more diagnostic codes, thereby providing preliminary associations between the input and the one or more diagnostic codes. Particularly, the processor 110 parses the text content of each unassociated problem-solution descriptions using the query/text parser 420. Based on the parsing of each respective unassociated problem-solution, the processor 110 matches the unassociated problem-solution with one or more diagnostic codes using the search index 410 and the results generator 430.

In other words, processor 110 leverages a searching mechanism (often used in the information retrieval area) in an unsupervised manner to determine preliminary associations between diagnostic codes and unassociated problem-solution descriptions based on the similarity with gold standard problem-solution descriptions. In this determination, the search index 410 indirectly provides initial supervision signals for building the high quality semi-gold-standard training data, that can supplement the gold-standard training data in the training of the model(s) 34 for associating problem-solution descriptions with diagnostic codes. It should be appreciated that the search index 410, in essence, can provide unsupervised or weakly supervised matching because the unassociated problem-solution descriptions will inherently be similar some of the gold-standard problem-solution description and the search index 410 enables the processor 110 to leverage those similarities to determine possible associations of the unassociated problem-solution descriptions with respective diagnostic codes.

Using the search index 410, the processor 110 compares the unassociated problem-solution descriptions with the indexed gold-standard training data to determine which gold-standard tuples are most similar to the unassociated problem-solution descriptions. From comparison results, the processor 110 determines which diagnostic codes are more likely to be associated with the respective unassociated problem-solution description. For each respective unassociated problem-solution description, the processor 110 determines a confidence score for each respective gold-standard tuple indicating a similarity between the respective unassociated problem-solution description and the respective gold-standard tuple.

The processor 110 determines the confidence score for each matching gold-standard tuple using any of a variety of known scoring schemes to provide accurate matching between the unassociated problem-solution descriptions and the gold-standard tuples. In one embodiment, the processor 110 determines the confidence scores using a bag-of-words retrieval/ranking function, such as a typical BM25 (best matching 25) or BM25F ranking function. We note that definition of “matching” can vary depending on the domain or the characteristics of data, i.e., topological similarity, statistical similarity, or at least semantics-based similarity can be considered here. Nonetheless, in at least some embodiments, the processor 110 determines the gold-standard tuples with the highest confidence scores as those with the most matching/similar keywords.

Thus, as shown in FIG. 8, the query results for a respective unassociated problem-solution description consist of a list of matching gold-standard tuples, which themselves comprise a problem-solution description paired with a diagnostic code, and corresponding confidence scores. As can be seen in the example of FIG. 8, diagnostic codes are sometimes repeated in the results, such as the illustrated two gold-standard tuples for the diagnostic code “P0171” because multiple different problem-solution descriptions with identical diagnostic codes will generally exist in the gold-standard training data.

The size of the returned result will be the size of the gold-standard training dataset because, given a respective unassociated problem-solution description, the processor 110 compares the respective unassociated problem-solution description with all the problem-solution descriptions in the gold-standard training data. However, in at least some embodiments, the processor 110 is configured to return only a limited set of S results having the highest confidence scores, where the number of results S can be set by the user in advance (e.g., 10≤S≤50).

In one embodiment, the processor 110 is configured to utilize fuzzy/approximate string-matching scheme to improve the coverage of the matching. Particularly, when comparing the parsed text of each unassociated problem-solution description with the words of the search index 410, the processor 110 finds words that match a pattern approximately (rather than 100% exact match), which allows the processor 110 to find matches over any words with very similar spells (e.g., color and colour) or even typos in problem-solution descriptions.

In one embodiment, the processor 110 is also configured to infuse synonyms into the unassociated problem-solution descriptions to improve the coverage of the matching. Particularly, for at least some of the individual unassociated problem-solution descriptions, the processor 110 generates at least one additional unassociated problem-solution description by substituting words in the unassociated problem-solution with synonyms for those words. The processor 110 matches the additional unassociated problem-solution description with diagnostic codes using the search index 410 in the same manner as discussed above. In one embodiment, the processor 110 determines the synonyms using language dictionary. Alternatively, in some embodiments, the processor 110 determines the synonyms using common word embeddings techniques (e.g., word2vec, doc2vec), which are built from input records or other external datasets such as Wordnet or ConceptNet. For example, if a problem-solution description contains the word “car”, the processor 110 generates additional problem-solution descriptions that instead contain similar, relevant words such as “vehicle”, “automotive,” “automobile” etc., so that the coverage of the matching can be further increased.

Returning to FIG. 6, the method 300 continues with applying at least one heuristic mechanism to eliminate incorrect associations of the plurality of unassociated problem-solution descriptions with respective diagnostic codes (block 330). Particularly, the processor 110 applies at least one heuristic mechanism and/or performs at least one process to eliminate incorrect associations from the preliminary associations between diagnostic codes and unassociated problem-solution descriptions. Particularly, in the example of FIG. 8, five different preliminary associations are returned from the gold-standard training data based on the input unassociated problem-solution description. In these results, four different diagnostic codes are preliminarily associated with input unassociated problem-solution description: “P0170,” “P0171,” “P0201,” and “P1203.” Among them, it is likely that “P0171” is the correct association because their confidence scores are much higher than those of the other diagnostic codes. However, it's also possible that the preliminary associations here are incorrect due to several unexpected reasons, e.g., typos in the descriptions can prevent them from being matched, or the authors of the descriptions could use completely different sets of the terminologies while their semantics are still very similar. To minimize incorrect associations, the processor 110 uses the heuristic mechanisms or other processes to refine the preliminary associations by filtering out false-positive preliminary associations and verifying the remaining true-positive associations.

In at least one embodiment, the processor 110 advantageously applies a plurality of different heuristic mechanisms and/or performs a plurality of different processes to eliminate incorrect associations from the preliminary associations, using a combination of different approaches. The processor 110 combines the results plurality of different heuristic mechanisms and/or the plurality of different processes to eliminate incorrect associations of the plurality of problem-solution descriptions with respective diagnostic codes

Particularly, to provide an effective verification process, the processor 110 dynamically combines different types of mechanisms using any of a variety of meta-models, e.g., any linear regression models or even neural networks. More formally, the processor 100 employs k heuristic mechanisms or processes where each ith mechanism, mᵢ, can be expressed as a function fᵢ(x). This function accepts a list of preliminarily associated tuples x (i.e., the matched tuples for an inputted unassociated problem-solution description), where the jth preliminarily associated tuple tⱼ= [symbol] dⱼ, cⱼ, sⱼ [symbol] in the list consists of three items: 1) a problem-solution description dⱼ, 2) a preliminarily associated diagnostic code cⱼ, and 3) a confidence score sⱼ. Each function fᵢ(x) return a result score rᵢ. Thus, each mechanism mᵢ is built as a sub-component of the filtering/verification process. For each inputted unassociated problem-solution description, the processor 110 applies each mechanism mᵢ to generate a result score rᵢ for each of the preliminarily associated tuples tⱼ.

Any of a variety of models can be used for combining these fᵢ(x). For example, in one embodiment, the processor 110 uses a simple linear model for combining the output of fᵢ(x). The processor 110 assigns a unique weight wᵢ for each function fᵢ(x), which is pre-assigned or pre-configured by users based on its credibility and usefulness. For each of the preliminarily associated tuples ti, the processor 110 computes the final result vector r for as a sum of the product of each mechanism's result score rᵢ and its unique weight wᵢ. In some embodiments, the processor 110 incorporates a default, minimum threshold value/constant b into the sum, to arrive at the final result vector r for each of the preliminarily associated tuples tⱼ. In other terms, the processor 110 calculates the final result vector r according to the equation:

$$r = b + {\sum }_{i} {w}_{i} {f}_{i} ( x )$$

As a final step, for each inputted unassociated problem-solution description, the processor 110 selects tuples from the list of preliminarily associated tuples x, each now having a final result vector r. For this purpose, the processor 110 sets a final threshold t and compares the final result vector r for each preliminarily associated tuple in the list x. The processor 110 filters out preliminarily associated tuples from the list x if the corresponding final result vector r is less than the final threshold t. If there are still multiple tuples in the list x for which the corresponding final result vectors r are greater than the final threshold t, the processor 110 selects the tuple in the list x with the maximum confidence score as the output or considers all the remaining tuple in the list x as to be correct associations for the inputted unassociated problem-solution description, thereby selecting multiple tuples as the final output. In some embodiments, the processor 110 applies an activation function to the final result vectors r to select the tuple(s) from the list x to be the final output. Such an activation function may include any activation function used in neural networks models, such as sigmoid and ReLU (rectified linear unit).

A wide variety of different heuristic mechanisms mᵢ can be employed during the filtering/verification of the list x of preliminarily associated tuples. The term “heuristic,” as used herein, should not be understood to limit the types of processes that can be employed for each of the mechanisms mᵢ and is merely descriptive of the general character of the detailed examples included herein. Below, we discuss several exemplary heuristic mechanisms that can verify or filter out some of the preliminarily associated tuples from the list x generated for each inputted unassociated problem-solution description.

As a first exemplary heuristic mechanism mᵢ, the processor 110 applies a rule-based filter to the list x of preliminarily associated tuples. Rule-based filters generally refer to the application of “If-Then” statements or “situation—action” pairs. In each case, the “If” portion of the rule specifies aspects of a situation/conditions and the “Then” portion specifies to one or more actions that are performed if the specified situation/conditions are satisfied. A rule-based filter can contain one or more rule sets. Each rule set includes one or more rules and/or nested rule sets. Based on a result of the application of the rule-based filter, the processor 110 determines a respective result score rᵢ for each of the preliminarily associated tuples tⱼ. Based on the result score rᵢ, the processor 110 may eliminate incorrect preliminary associations.

One example of a rule-based filter is keyword-matching over specific categories or parameters used in descriptions. For example, it may be desirable to filter out or give lower result scores if any problem-solution descriptions include the keyword “carburetor”, which implies that they are likely to be outdated ones (i.e., fuel injection technology has largely replaced carburetors in the automotive these days). In this way, administrators can set any combinations of IF-THEN rules with string or value-based filters as needed.

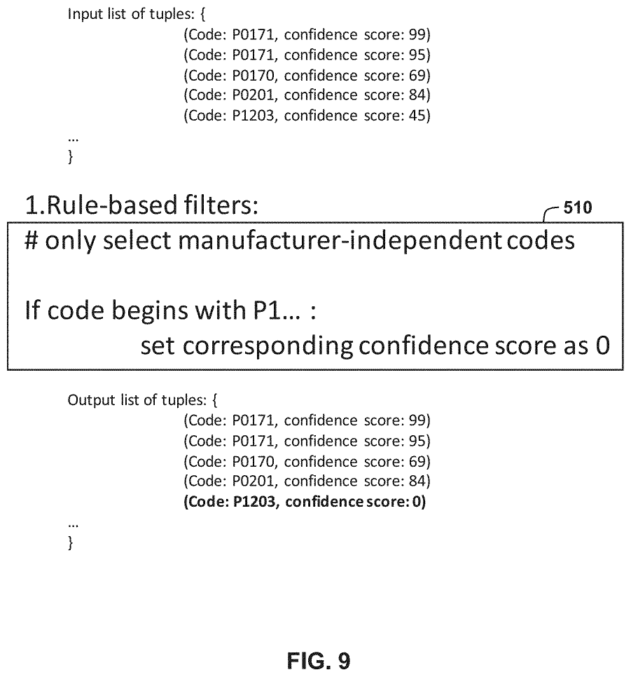

FIG. 9 shows a further example in which a rule-based filter 510 is applied to give preference to brand-independent problem-solution descriptions. In OBD-II code specifications, the diagnostic code that begins with the prefix “P1 . . . ” means that the code is a manufacturer-specific code. Based on this pattern, the processor 110 can apply a simple ruleset that filters out the tuples if their diagnostic codes have the prefix “P1 . . . ”. The filtering out here means that the processor 110 sets the result score rᵢ for such codes as the minimum score value, e.g., 0, when the range of the result score is from 0 to 100. In one embodiment, for supporting the use of this type of ruleset, the processor 110 utilizes a semantic reasoner, such as Drools and Jena, which infers logical consequences from asserted facts or axioms. In this case, the processor 110 applies the rules over problem-solution descriptions, search patterns using regular expressions or other pattern languages are specified because the descriptions are generally natural language sentences, not formally represented axioms.

As a second exemplary heuristic mechanism mᵢ, the processor 110 applies a human-in-the-loop process to the list x of preliminarily associated tuples. Particularly, a human-in-the-loop approach leverages the assistance of human reviewers who are, for example, domain experts or random groups of people from crowdsourcing platforms. In one embodiment, the processor 110 divides the list x of preliminarily associated tuples into several groups/chucks so that a human reviewer can review each group. The processor 110 provides the groups of preliminarily associated tuples to a client device or display device that is accessible to the human reviewer and via which the human reviewer can provide user inputs. The human reviewer reviews each preliminary result that contains potential associations with confidence scores or a certain number of the samples. Once the reviewers finish their review process, the processor 110 receives user inputs via which the human reviewer can set or adjust one or more of the result scores rᵢ for the preliminarily associated tuples tⱼ. For example, if the human reviewer fully agrees with the preliminary association result for a specific diagnostic code (i.e., a problem-solution description is certainly associated with the diagnostic code), the processor 110 sets the result score rᵢ to be the maximum score. Conversely, if the human reviewer fully disagrees, the processor 110 sets the result score rᵢ to be the minimum score. In this way, this heuristic mechanism allows the system to collect feedback from human experts and transform their opinions into quantified scores regarding the preliminary associations. Based on the result score rᵢ, the processor 110 may eliminate incorrect preliminary associations.

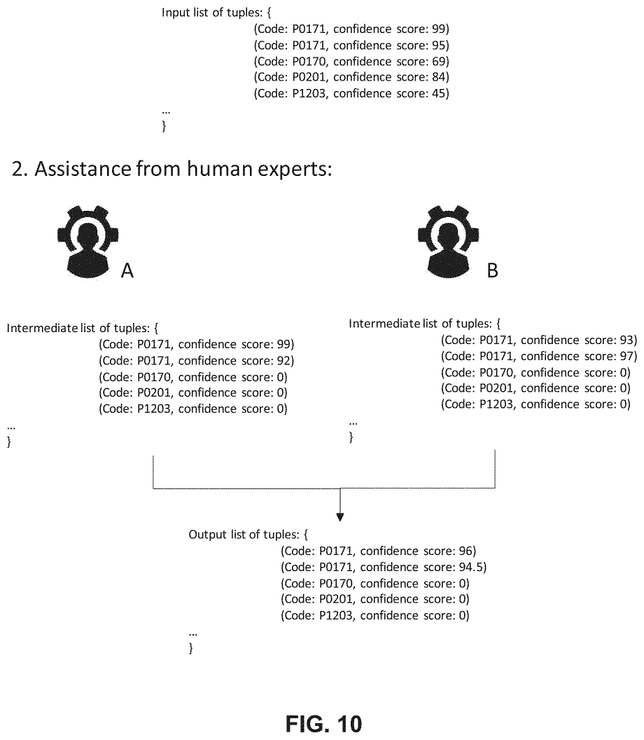

It should be appreciated that a single expert's opinion may not be so reliable. Accordingly, in some embodiments, the processor 110 utilizes two different human reviewers to provide cross-validations, such as requiring agreement between overlapping or repeating groups that are assigned to the human reviewers. In one embodiment, the processor 110 uses average or median values of the result scores rᵢ from repeatedly assigned preliminarily associated tuples tⱼ. FIG. 10 illustrates a human-in-the-loop approach in which independent reviewers A and B review the identical preliminary result independently. In the illustrated example, the reviewers A and B assign different result scores rᵢ for the same preliminary associations, i.e., these reviewers assigned slightly different result scores rᵢ for the descriptions associated with the code P0171, while assigning 0 to the other codes. In one embodiment, the processor 110 computes and returns the average values of these result scores rᵢ as a result of this heuristic mechanism. In other embodiments, the processor 110 may utilize other strategies for settling the differences between the result scores rᵢ of different reviewers, such as utilizing other mathematical functions (e.g., median), etc.

As a third exemplary heuristic mechanism mᵢ, the processor 110 applies an unsupervised learning technique to the list x of preliminarily associated tuples. Particularly, heuristics using an unsupervised approach such as clustering can be used to additionally verify the associations made from the initial association step or from other heuristics. Based on a result of the unsupervised learning technique, the processor 110 determines a respective result score rᵢ for each of the preliminarily associated tuples tⱼ. Based on the result score rᵢ, the processor 110 may eliminate incorrect preliminary associations.

In one example, the processor 110 determines word embeddings or feature vectors over a “mixture” of the problem-solution descriptions in the gold-standard tuples and all of the inputted unassociated problem-solution descriptions using a word embedding technique (e.g., word2vec or doc2vec). Next, the processor 110 applies a proper clustering algorithm over the word embeddings of problem-solution descriptions, building the clusters of the descriptions. The processor 110 uses these clustering results to determine a result score rᵢ for the preliminarily associated tuples tⱼ.

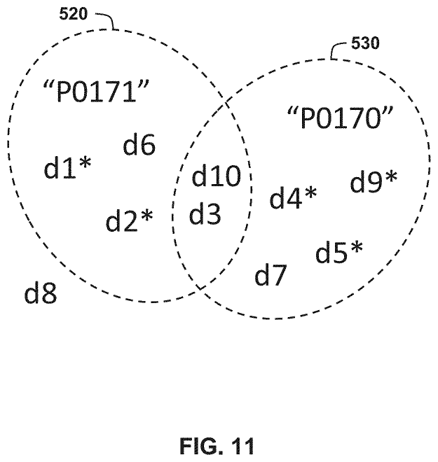

FIG. 11 shows an exemplary clustering in which there are two clusters for two diagnostic codes: “P0170” and “P0171.” In the example, there are ten preliminarily associated problem-solution descriptions d1-d10. The processor 110 cross-checks if the preliminarily associated problem-solution descriptions d1-d10 also exist in those clusters properly. In the illustration, the descriptions denoted with the asterisk * refer are descriptions from the gold-standard tuples. As can be seen, some descriptions are not placed in the appropriate cluster, e.g., the description d8 is associated with the code P0171, but the description d8 does not exist in the cluster for P0171, nor does the description d8 exist in other clusters. Thus, the processor 110 assigns a reduced result score rᵢ to the preliminarily associated tuple including the description d8. Similarly, the descriptions d3 and d10 exist in both clusters, which may be possible because some problems and solutions can be related to multiple diagnostic codes. Thus, the processor 110 assigns a reduced result score rᵢ to the preliminarily associated tuple including the descriptions d3 and d10, because of this uncertainty. Particularly, it is likely that such cases are not that common and, therefore, the initial association result may be wrong. Moreover, it is also possible that the algorithms for building the clusters may have some problems. In that case, the processor 110 may flag these descriptions for review by human experts (as described above) or cross-check them using other available mechanisms.

Mixing the gold standard and unassociated problem-solution descriptions is similar to the situation where class labels are known for a subset of the observations. Generally, the processor 110 utilizes common solutions such as constrained k-means to effectively construct clusters while considering such constraints (i.e., a subset of the observations). Nonetheless, other available clustering algorithms can be used as well, depending on the context, such as the number of descriptions, i.e., the processor 110 performs some additional sanity checks or validations of the constructed clusters. For example, in one embodiment, the processor 110 selects a random cluster and samples some gold-standard tuples from that cluster. Next, the processor 110 checks if all the sampled gold tuples share the same diagnostic codes. If they do, the clusters computed are considered as the properly constructed ones. If not, the clusters are not properly constructed. In the latter case, the processor 110 adjusts parameters or hyperparameters of the clustering algorithm and applies the clustering algorithm again until all (or at least a threshold amount) of the sampled tuples share the same diagnostic codes. The processor 110 then labels or annotates each cluster with the diagnostic codes. FIG. 7 shows a simplified version of the visualization of the labeled clustering, i.e., the left cluster 520 is for the code “P0171,” and the right cluster 530 is for the code “P0170,” etc.

This unsupervised validation approach described here may have some similarities with external validation techniques often used in clustering algorithms. The general idea is that assuming that the true cluster labels are available, the processor 110 can measure the statistical similarity between the two sets, i.e., the resulting set of a certain clustering algorithm vs. the true cluster set. After then, the resulting clustering set is considered good if it is highly similar to the true cluster set. In the present case, however, a true cluster set constructed from all of the problem-solution descriptions is not available because most descriptions are not yet associated with diagnostic codes except a few gold standards. However, by using the search index 410 and using the clustering approach independently and respectively, the processor 110 can eventually determine two sets and then can measure the statistical similarity between these two sets. This measurement itself may not be able to fully guarantee that the result set using the search index 410 is sufficiently correct. However, because these sets are cross-validated multiple times using other approaches such as the rule-based filters or the human-in-the-loop approach, the processor 110 can effectively filter out most negative cases in high confidence, constructing the set, which is very close to the true cluster set in the end.

As a fourth exemplary heuristic mechanism mᵢ, the processor 110 applies a supervised learning technique to the list x of preliminarily associated tuples. Particularly, heuristics using a supervised approach also can be used for verifications. Based on a result of the supervised learning technique, the processor 110 determines a respective result score rᵢ for each of the preliminarily associated tuples tⱼ. Based on the result score rᵢ, the processor 110 may eliminate incorrect preliminary associations.

For example, sometimes, human experts are already aware of correlations between keywords/phrases and diagnostic codes. In some cases, such correlations are even already documented. To leverage such correlations, the processor 110 first receives and/or determines pairs of (i) keyword/phrase sets and (ii) associated diagnostic codes. For example, common symptoms of the diagnostic code “P0171” in the OBD II standard often include the keywords or key phrases such as “loss of power,” “check engine light,” “hesitation or stumble from the engine,” “engine may be difficult to start,” “engine may die,” “catalytic converter damage may result if this code is stored for a long period of time,” etc. Such keywords/phrases for diagnostic codes can be obtained from domain experts. Alternatively, the processor 110 can extract such keyword/phrases from the gold-standard training data using any available keyword/phrases extraction techniques. Once a complete keywords/phrases sets are available (e.g., sets that cover all the diagnostic codes in the gold-standard training data), the processor 110 trains a supervised model of any kind (e.g., a neural network) using the pairs.

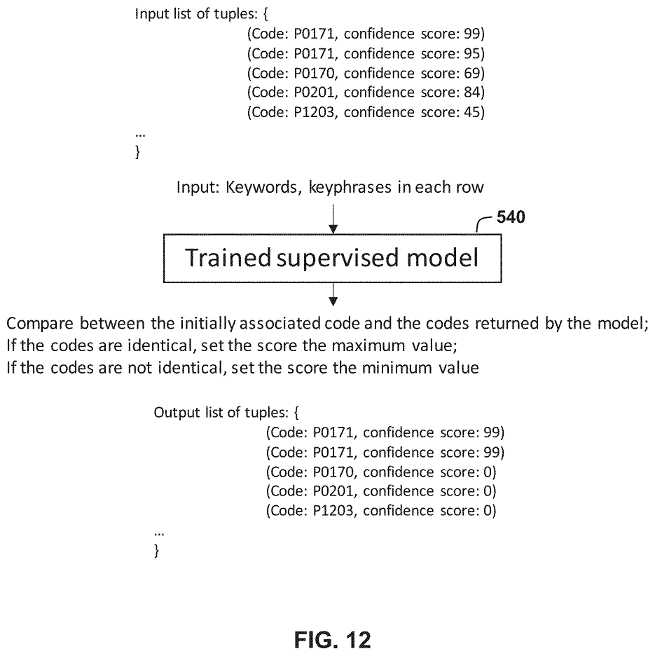

Once the supervised model is trained, the processor 110 feeds keywords/phrases extracted from each inputted unassociated problem-solution description into the supervised model and compares the output with the diagnostic codes in the preliminarily associated tuples tⱼ. FIG. 12 shows an exemplary heuristic process using a trained supervised model 540 and a simple binary scoring scheme. If an output diagnostic code is the same as the one in a preliminarily associated tuple tⱼ, then the processor 110 sets the result score rᵢ to the maximum value (e.g., 99). On the contrary, if the model returns a different code, then the processor 110 sets the result score rᵢ to the minimum value (e.g., 0). It will be appreciated that other types of schemes are also possible, e.g., adding or removing a certain amount from the original confidence scores of the preliminarily associated tuple tⱼ, etc. In these ways, the supervised approach can provide a further verification mechanism to double-check the results generated by the preliminary association step.

In some embodiments, based on the amount and qualities of gold standard and unassociated problem-solution description datasets, the processor 110 automatically (or based on user inputs) adjusts the parameters for each of the heuristic mechanisms, i.e., the processor 110 can selectively include or remove these approaches as needed. Additionally, in some embodiments, the processor 110 automatically (or based on user inputs) adjusts the weight wᵢ for each mechanism as required. For example, if the human expert's opinions matter, the user can assign much higher weight values for the exemplary human-in-the-loop heuristic.

Returning to FIG. 6, the method 300 continues with determining the second plurality of training data pairs as the remaining associations of the plurality of unassociated problem-solution descriptions with respective diagnostic codes (block 340). Particularly, the processor 110 generates the second plurality of training data pairs, referred to herein as the “semi-gold-standard” training data, as including the remaining tuples from list x of preliminarily associated tuples which has been refined, filtered, and verified by the heuristic mechanisms mᵢ. As discussed above, the semi-gold-standard training data comprises pairwise associations between diagnostic codes and problem-solution descriptions, and generally form the remainder of or at least a subset of the associated tuples 160, discussed above. Combined with the gold-standard training data, the semi-gold-standard training data enable training of the model(s) 34 for associating problem-solution descriptions with diagnostic codes.

Returning to FIG. 5, the method 200 continues with training a model using the first and second pluralities of training data pairs, the model being configured to associate problem-solution descriptions with diagnostic codes (block 240). Particularly, the processor 110 trains one or more model(s) 34 using the combined gold-standard and semi-gold-standard training data. The model(s) 34 may include any of a variety of machine learning model, such as neural networks, and may be trained according to a variety of known supervised learning techniques. In one embodiment, the processor 110 trains a first model configured to map an input problem-solution description to at least one diagnostic code. In one embodiment, the processor trains a second model configured to map an input diagnostic code to at least one problem-solution description in the database 32. In some embodiments, the model(s) 34 are trained using an NLP platform or libraries here such as NLTK, Gensim, or Spacy.

The trained model(s) 34 can be used for a variety of purposes to enable the functionality of the problem assistance system 10, discussed above. Particularly, in some embodiments, the processor 110 utilizes the trained model(s) 34 to populate the database 32 with a large number of problem-solution descriptions and associated diagnostic codes, using the model(s) 34. Particularly, as discussed above, additional problem-solution descriptions may be retrieved from a variety of sources, such as from technical manuals or books retrieved from digital libraries, as well as text information retrieved from Internet forums, blogs, or other websites. Such sources can be continuously or periodically monitored for new content, and incorporated into the database 32 using the trained model(s) 34, thereby expanding the plurality of associated tuples 160.

Additionally, in some embodiments, the processor 110 utilizes the trained model(s) 34 to perform searches over the plurality of associated tuples 160 (and/or the unassociated tuples 170) in the database 32. Particularly, the processor 110 receives a search query from a user, which may have been entered, for example, using the search box 62 of the graphical user interface 60 (FIG. 3). The search query may include text such as a diagnostic code, a problem description, or keywords. In some embodiments, the processor 110 converts the search query into a word embedding (e.g., using word2vec or doc2vec). The processor 110 feeds the search query into the trained model(s) 34, and performs a search of the plurality of associated tuples 160 (and/or the unassociated tuples 170) in the database 32 based on the output of the trained model(s) 34 resulting from feeding in the search query.

It should be appreciated that the performance of the trained model(s) 34 depends on how large the combined gold-standard and semi-gold-standard training dataset is and how well the combined training data are distributed across the diagnostic codes. Good performance will be achieved if all or most diagnostic codes are associated with a sufficiently large and relatively equal amount of training tuples. However, in some case, it is possible that even after generating the semi-gold-standard training data, the total amount of training data remains insufficient. Particularly, in some instances, the amount of the training data tuples is still less than necessary for good performance. Additionally, in some instances, the training data tuples may be very skewed, i.e., a few diagnostic codes are associated with a large number of tuples while other diagnostic codes still do not have a sufficient number of descriptions. In these cases, it is likely that training the model(s) 34 with the combined training data will not produce satisfying results due to the lack of sufficient training data.

In the case that the total amount of training data remains insufficient, the blocks 220 and 230 of the method 200 can be repeated if another alternative data source is available to acquire further unassociated problem-solution descriptions. Nonetheless, it is also possible that there are not further alternative data sources available. In this case, the data can be reviewed to check which diagnostic codes have an insufficient amount or any missing problem-solution descriptions. It should be appreciated that, in some machine learning problems, it may not be a significant problem if some labels are not used for labeling training data. However, in the present case, it is important that all the labels, i.e., diagnostic codes, have at least a minimum number of associated problem-solution descriptions to provide useful training datasets that cover all the problems that can occur from the machines or devices. Particularly, if some diagnostic codes do not have sufficient training data, then the trained model(s) 34 might return completely out-of-context diagnostic codes and/or problem-solution descriptions when users query the model using such codes. This could guide users in a wrong direction, waste their efforts, and even cause any potential accidents, etc.

To avoid such unintended situations, for the codes that have less than the minimum number of associated problem-solution descriptions, it is advantageous to obtain additional problem-solution descriptions for these codes. In some embodiments, the processor 110 synthesizes a third plurality of training data pairs, referred to herein as the “synthesized” training data. In one embodiment, the processor 110 synthesizes additional associated problem-solution descriptions for at least some of the diagnostic codes using definitions of the diagnostic codes and then adds the synthesized associated problem-solution descriptions to the training data for those diagnostic codes. The user (e.g., a system administrator) can adjust the minimum number of problem-solution descriptions required for each diagnostic code (e.g., 50 associated problem-solution descriptions).

For example, assume that the OBD II diagnostic code “P0128” does not have sufficient associated problem-solution descriptions in the training data. The minimum default description of the OBD II diagnostic code “P0128” is “coolant thermostat (coolant temperature below thermostat).” The processor 110 synthesizes additional associated problem-solution descriptions for by injecting 1) the words from original descriptions and their synonyms such as “defective,” “cooling,” “temperature,” and “sensor” and 2) additional comments that inform readers or users, e.g., “This diagnostic code, P0128, does not have a sufficient number of descriptions at this moment. Please get in touch with domain experts if needed”, etc.

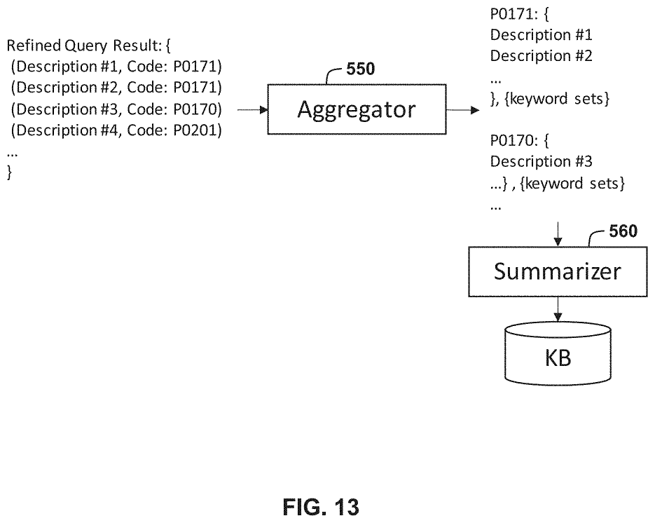

In some embodiments, the processor 110 utilizes the trained model(s) 34 and/or the plurality of associated tuples 160 to generate a knowledge base for storage in the database 32. A knowledge base can provide an alternative search/browsing/retrieval mechanism for users. FIG. 13 shows an exemplary process of constructing knowledge bases from the refined plurality of associated tuples 160. First, the processor 110 aggregates the plurality of associated tuples 160 using an aggregator 550, which re-groups the tuples by their diagnostic codes so that all the tuples describing a certain identical parameter can be grouped using map/dictionary/key-value data structures where its key is a specific diagnostic code and their values are the associated problem-solution descriptions. For each diagnostic code, the processor 110 extracts keyword sets from the associated problem-solution descriptions using any available keyword/phrases extraction techniques, and associates the keyword set with the diagnostic code. Next, the processor 110 generates summaries of the keywords and the problem-solution descriptions associated with the diagnostic codes by feeding them into a summarizer 560. Using the summarizer 560, the processor 110 generates concise summary descriptions by aggregating similar descriptions and removing repeated, similar descriptions from aggregated results, producing concise descriptions with less than m words, where the value of m can be determined by administrator or operators of the knowledge bases.

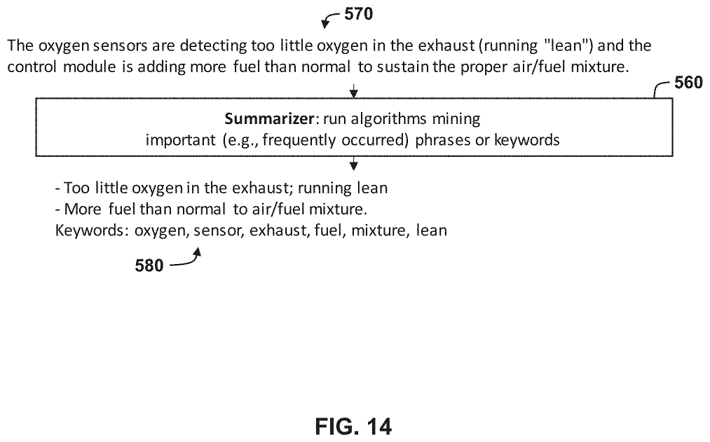

FIG. 14 shows an example input and output of the summarizer 560 on the descriptions of the problems for the diagnostic code “P0171.” The processor 110 uses the summarizer 560 to accept an input 570 (e.g., natural language sentences of the problem description) and generate an output 580 (e.g., two key phrases and a set of keywords). In one embodiment, the processor 110 uses a set of different schemes to produce concise descriptions from sentences, such as only returning frequently occurred keywords or phrases by applying common scoring schemes such as TF-IDF or BM25F over the whole input 570 for the respective diagnostic code, etc. The processor 110 then stores the output 580 in the knowledgebase that indexes the data by key (diagnostic code) and by value (problem-solution description and additional meta-information such as keywords and authors) in the output. A variety of different types of storage and index formats can be used based on the data models used in knowledge bases, e.g., directed labeled graph structures such as RDF or common structural formats such as XML or JSON. The knowledge base may be stored in the database 32 or may be stored in a separate data storage device.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for associating diagnostic codes with problem-solution descriptions, the method comprising:
receiving, with a processor, a first subset of a plurality of training data pairs, each training data pair in the first plurality of training data pairs including (i) a respective diagnostic code and (ii) a respective problem-solution description associated with the respective diagnostic code;
receiving, with the processor, a plurality of problem-solution descriptions that are not yet associated with any diagnostic codes;
generating, with the processor, a second subset of the plurality of training data pairs by associating the plurality of problem-solution descriptions with respective diagnostic codes, using the first subset of the plurality of training data pairs; and
training, with the processor, a model using on the plurality of training data pairs, the at least one model being configured to associate diagnostic codes with problem-solution descriptions.

2. The method according to claim 1, the generating the second subset of the plurality of training data pairs further comprising:
generating a search index based on the first subset of the plurality of training data pairs; and
associating each of the plurality of problem-solution descriptions with respective diagnostic codes from the first subset of the plurality of training data pairs using the search index.

3. The method according to claim 2, the associating each of the plurality of problem-solution descriptions with respective diagnostic codes further comprising:
comparing each of the plurality of problem-solution descriptions with each respective problem-solution description from the first subset of the plurality of training data pairs using the search index.

4. The method according to claim 3, the comparing further comprising:
comparing words in each of the plurality of problem-solution descriptions with words in the search index using a fuzzy matching technique.

5. The method according to claim 2, the generating the second subset of the plurality of training data pairs further comprising:
generating a further problem-solution descriptions by substituting synonymous words into the plurality of problem-solution descriptions; and
associating the further problem-solution descriptions with respective diagnostic codes using the search index.

6. The method according to claim 2, the generating the second subset of the plurality of training data pairs further comprising:
determining a confidence score for each association of the plurality of problem-solution descriptions with respective diagnostic codes.

7. The method according to claim 2, the generating the second subset of the plurality of training data pairs further comprising:
performing at least one process to eliminate incorrect associations of the plurality of problem-solution descriptions with respective diagnostic codes; and
determining second subset of the plurality of training data pairs as a set of remaining associations of the plurality of problem-solution descriptions with respective diagnostic codes.

8. The method according to claim 7, the performing the at least one process further comprising:
applying a rule to the associations of the plurality of problem-solution descriptions with respective diagnostic codes;
eliminating an incorrect association of a respective one of the plurality of problem-solution descriptions with a respective diagnostic code depending on a result of applying the rule.

9. The method according to claim 7, the performing the at least one process further comprising:
receiving user inputs regarding the associations of the plurality of problem-solution descriptions with respective diagnostic codes;
eliminating an incorrect association of a respective one of the plurality of problem-solution descriptions with a respective diagnostic code depending on the user inputs.

10. The method according to claim 7, the performing the at least one process further comprising:
determining a plurality of word embeddings for the plurality of problem-solution descriptions and the respective problem-solution descriptions of the first plurality of training data pairs;
clustering the word embedding using a clustering technique; and
eliminating an incorrect association of a respective one of the plurality of problem-solution descriptions with a respective diagnostic code depending on the clustering of the word embeddings.

11. The method according to claim 7, the performing the at least one process further comprising:
receiving further training data including a plurality of keywords associated with respective diagnostic codes;
training a further model to associate keywords with diagnostic codes using the further training data; and
eliminating an incorrect association of a respective one of the plurality of problem-solution descriptions with a respective diagnostic code using the supervised model.

12. The method according to claim 7, the performing the at least one process further comprising:
performing a plurality of processes; and
combining results of the plurality of processes to eliminate incorrect associations of the plurality of problem-solution descriptions with respective diagnostic codes.

13. The method according to claim 12, the combining the results of the plurality of processes further comprising:
combining results of the plurality of processes using a weighted sum.

14. The method according to claim 1 further comprising:
generating, with the processor, a third subset of the plurality of training data pairs by synthesizing further plurality of problem-solution descriptions for a respective diagnostic code based on a definition of the respective diagnostic code.

15. The method according to claim 1, the training the model further comprising:
training a first model configured to map an input problem-solution description to at least one diagnostic code.

16. The method according to claim 1, the training the model further comprising:
training a second model configured to map an input diagnostic code to at least one problem-solution description.

17. The method according to claim 1 further comprising:
generating, with the processor, a knowledge base by generating summaries of problem-solution descriptions associated with each diagnostic code.

18. The method according to claim 1 further comprising:
populating, with the processor, a database of problem-solution descriptions and associated diagnostic codes, using the model.

19. The method according to claim 1 further comprising:
receiving, with the processor, a search query from a user; and
searching, with the processor, a database of problem-solution based on the search query.

20. The method according to claim 19, the searching the database further comprising:
feeding the search query into the model; and
searching the database using a result of the feeding the search query into the model.
